(19) United States
(12) Patent Application Publication
(10) Pub. No.: US 2025/0392780 A1
(43) Pub. Date: Dec. 25, 2025

(54) WIRELESS TRANSMITTING DEVICE AND WIRELESS DISPLAY SYSTEM

(71) Applicant: LG ELECTRONICS INC., Seoul (KR)

(72) Inventor: Dongsung KIM, Seoul (KR)

(73) Assignee: LG ELECTRONICS INC., Seoul (KR)

(21) Appl. No.: 18/985,726

(22) Filed: Dec. 18, 2024

(30) Foreign Application Priority Data
Jun. 19, 2024 (WO) PCT/KR2024/008479

(51) Int. Cl. H04N 21/4363; H04N 19/137; H04N 21/426

(52) U.S. Cl. CPC H04N 21/43637; H04N 19/137; H04N 21/42607

(57) ABSTRACT

A wireless transmitting device according to an embodiment of the present disclosure may comprise a compression chip configured to compress image data; an RF (Radio Frequency) transmitting interface configured to, wirelessly, transmit the compressed image data to a wireless receiving device; and a processor configured to: obtain a light blocking state of a display provided in the wireless receiving device, and adjust a compression rate of the image data based on the obtained light blocking state.

### CROSS-REFERENCE TO RELATED APPLICATION

Pursuant to 35 U.S.C. § 119, this application claims the benefit of an earlier filing date and right of priority to International Application No. PCT/KR2024/008479, filed on Jun. 19, 2024, the contents of which are hereby incorporated by reference herein in its entirety.

### BACKGROUND OF THE INVENTION

### 1. Field of the Invention

This disclosure relates to a wireless display system that transmits and receives A/V data wirelessly.

### 2. Discussion of the Related Art

Digital TV service using wired or wireless communication network is becoming popular. Digital TV service may provide a variety of services that cannot be provided by existing analog broadcasting service.

For example, IPTV (Internet Protocol Television) and smart TV service, which are types of digital TV service, provide interactivity that allows a user to actively select the type of program to watch and the viewing time. IPTV and smart TV services may provide various additional services, such as Internet search, home shopping, and online game, based on this interactivity.

Recently, TV service is provided through a wireless system in which a wireless transmitting device transmits a compressed A/V (Audio/Video) signal to a wireless receiving device through a wireless connection, and the wireless receiving device decompresses and outputs the compressed A/V signal.

In a conventional wireless display system, an image data is compressed and transmitted equally regardless of a light blocking state or an ambient brightness of the display provided in the wireless receiving device.

Accordingly, there is a need to reduce a power consumption and improve a wireless quality.

### SUMMARY OF THE INVENTION

The purpose of the present disclosure may be to reduce a power consumption and improve a wireless communication quality by changing a compression rate of wirelessly transmitted image data according to the light blocking state of a display provided in the wireless display system.

The purpose of the present disclosure may be to reduce the power consumption and improve the wireless communication quality by changing a compression rate of wirelessly transmitted image data according to a degree of light blocking of the display provided in the wireless display system.

The purpose of the present disclosure may be to reduce the power consumption and improve the wireless communication quality by changing the compression rate of transmitted image data in consideration of the light blocking state and a ambient brightness of the display provided in the wireless display system.

A wireless transmitting device according to an embodiment of the present disclosure may comprise a compression chip configured to compressed image data; an RF (Radio Frequency) transmitting interface configured to, wirelessly, transmit the compressed image data to a wireless receiving device; and a processor configured to: obtain a light blocking state of a display provided in the wireless receiving device, and adjust a compression rate of the image data based on the obtained light blocking state.

A wireless display system including a wireless transmitting device and a wireless receiving device according to an embodiment of the present disclosure, wherein the wireless transmitting device is configured to: transmit a compressed image data to a wireless receiving device, obtain a light blocking state of a display provided in the wireless receiving device, and adjust a compression rate of the image data based on the obtained light blocking state, wherein the wireless receiving device is configured to: restore the compressed image data received from the wireless transmitting device and display an image based on the restored image data on the display, wherein the wireless receiving device includes a light blocking film disposed on one side of the display, and the light blocking film blocks light from an entire area or a partial area of the display using either a non-electronic light blocking method or an electronic light blocking method.

According to an embodiment of the present disclosure, when a light blocking film blocks an entire area of the display, a wireless transmitting device lowers the compression rate of an image data so that a viewer may watch a high-definition image.

In addition, according to an embodiment of the present disclosure, when the light blocking film does not block the entire area of the display, the wireless transmitting device may increase the compression rate of the image data to lower the power consumption of the wireless display system and appropriately respond to a wireless connection failure environment.

According to an embodiment of the present disclosure, when a content image is displayed in a light blocking area, an image quality may be improved by lowering the compression rate of the image data, and when an information image is displayed in the light blocking area, the wireless transmission quality may be improved by increasing the compression rate of the image data.

Additionally, according to an embodiment of the present disclosure, the image quality may be improved by lowering the compression rate of an image corresponding to the light blocking area, and the wireless transmission quality may be improved by increasing the compression rate of an image corresponding to a non-light blocking area.

According to an embodiment of the present disclosure, the compression rate of image data may be adjusted according to a transparency of an area formed by the display. Accordingly, unnecessary waste of power consumption may be reduced, and data may be transmitted efficiently even in a wireless failure environment.

According to an embodiment of the present disclosure, the compression rate may be adjusted according to the light blocking state of the display and a motion value of the image displayed on the light blocking area. Accordingly, the number of receiving antennas that are unnecessarily used may be reduced, thereby reducing power consumption.

### BRIEF DESCRIPTION OF THE DRAWINGS

FIGS. 1 to 2 are diagrams illustrating the configuration of a display system according to an embodiment of the present disclosure.

FIG. 3 is a block diagram illustrating the configuration of a remote control device according to an embodiment of the present disclosure.

FIG. 4A is a perspective view of a wireless transmitting device.

FIG. 4B is a diagram illustrating the internal structure of a wireless transmitting device.

FIG. 4C is a diagram illustrating the RF receiving interface of the wireless receiving device.

FIGS. 5A to 5C are diagrams illustrating a light blocking state according to an embodiment of the present disclosure.

FIGS. 6A and 6B are diagrams illustrating a non-electronic light blocking method according to an embodiment of the present disclosure, and FIG. 6C is a diagram illustrating an electronic light blocking method according to another embodiment of the present disclosure.

FIGS. 7A and 7B are diagrams illustrating various types of display according to embodiments of the present disclosure.

FIG. 8 is a sequence diagram for illustrating a method of operating a wireless display system according to an embodiment of the present disclosure.

FIGS. 9A to 9C are diagrams illustrating a method of controlling the compression rate of image data according to the operation of the non-electronic light blocking method according to an embodiment of the present disclosure.

FIG. 10 is a diagram illustrating a process for determining the compression rate based on the light blocking state and the ambient brightness of the display according to another embodiment of the present disclosure.

FIGS. 11A to 11D are diagrams illustrating an example of determining the compression rate of image data based on the type of image displayed in the light blocking area according to an embodiment of the present disclosure.

FIGS. 12A and 12B are diagrams illustrating an embodiment of selectively operating a plurality of RF receiving interfaces according to the light blocking state of the display when the wireless receiving device is equipped with the plurality of RF receiving interfaces.

FIG. 13 is a diagram illustrating a lookup table showing a correspondence between a transparency and a compression rate.

FIG. 14 is a flowchart illustrating a process of determining the compression rate based on the light blocking state of a display and the motion value of an image displayed in a light blocking area according to an embodiment of the present disclosure.

### DETAILED DESCRIPTION OF THE PREFERRED EMBODIMENTS

The wireless transmitting device according to an embodiment of the present disclosure is, for example, an intelligent device that adds a computer support function to the broadcast reception function, and is faithful to the broadcast reception function while adding an Internet function, etc, and it may be equipped with a more convenient interface such as a handwriting input device, a touch screen or a spatial remote control.

The wireless transmitting device may be connected to the Internet and a computer by supporting wired or wireless Internet function and may perform function such as email, web browsing, banking, or gaming. A standardized general-purpose OS may be used for these various functions.

Accordingly, in the wireless transmitting device described in the present disclosure, for example, various applications may be freely added or deleted on a general-purpose OS kernel, so various user-friendly functions may be performed.

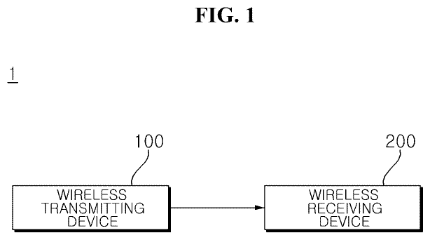

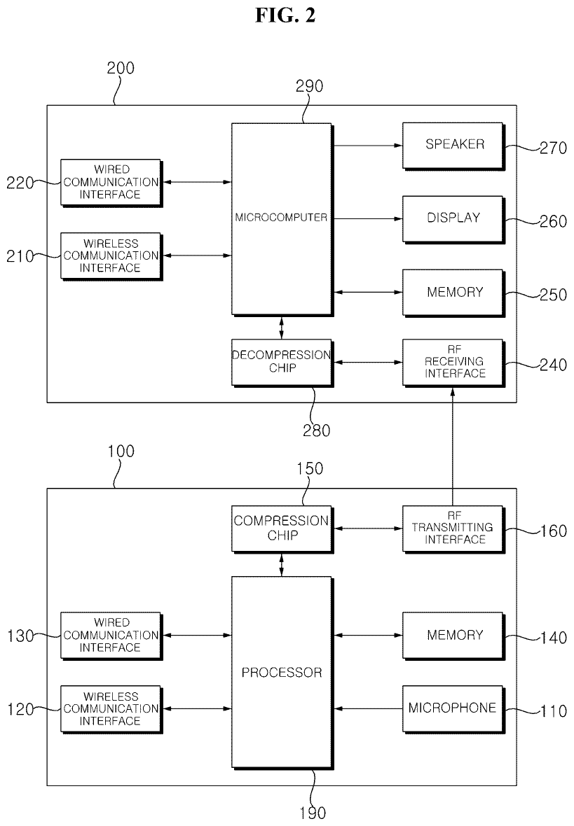

FIGS. 1 to 2 are diagrams illustrating the configuration of a wireless display system according to an embodiment of the present disclosure.

Referring to FIG. 1, a wireless display system 1 according to an embodiment of the present disclosure may include a wireless transmitting device 100 and a wireless receiving device 200.

The wireless display system 1 may be a system in which the wireless transmitting device 100 wirelessly transmits A/V data to the wireless receiving device 200, and the wireless receiving device 200 outputs the A/V data.

The wireless transmitting device 100 may be a device that encodes video and audio and transmits the encoded video and audio wirelessly.

The wireless transmitting device 100 may be a set-top box.

The wireless transmitting device 100 may be connected to an external device such as a set-top box or USB memory. The wireless transmitting device 100 may transmit a video signal or an audio signal received from a connected external device to the wireless receiving device 200.

The wireless receiving device 200 may be a display device capable of wirelessly receiving encoded video and audio and decoding the received video and audio.

The wireless transmitting device 100 and the wireless receiving device 200 may configure a video wall display system.

In a video wall, having a display with thin bezel plays an important role in the visualization of content video. In order to achieve a thin bezel of the display, it is efficient to have only the elements that play the minimum role, and to have the circuits and elements for the main functions performed in a separate device.

The wireless transmitting device 100 may determine the compression rate of the video based on either the type of video input from the outside or the quality of communication between the wireless transmitting device 100 and the wireless receiving device 200.

The compression rate of video may be defined as the ratio of the size of the video data before encoding and the size of the video data after encoding.

The type of video may be one of a still video type, a general video type, or a game video type.

The wireless transmitting device 100 may compress the video according to the determined compression rate and wirelessly transmit the compressed video to the wireless receiving device 200.

The wireless receiving device 200 may restore compressed video received from the wireless transmitting device 100 and display the restored video on a display.

FIG. 2 is a block diagram illustrating the detailed configuration of the wireless transmitting device 100 and the wireless receiving device 200.

Referring to FIG. 2, the wireless transmitting device 100 may include a microphone 110, a wireless communication interface 120, a wired communication interface 130, a memory 140, a compression chip 150, an RF transmitting interface 160, and a processor 190.

The microphone 110 may receive an audio signal and transmit it to the processor 190.

The microphone 110 may receive a voice uttered by a user.

The wireless communication interface 120 may include one or more of a Wi-Fi circuit and a Bluetooth circuit.

The Wi-Fi circuit may perform wireless communication with an external device or the wireless receiving device 200 through the Wi-Fi standard.

The Bluetooth circuit may perform wireless communication through the Bluetooth Low Energy (BLE) standard.

The Bluetooth circuit may perform wireless communication with an external device such as a remote control or the wireless receiving device 200 through the Bluetooth Low Energy (BLE) standard.

The wireless communication interface 120 may include a tuner that receives broadcast signals.

The wired communication interface 130 may be an interface for a wired connection with an external device. The wired communication interface 130 may include a plurality of High Definition Multimedia Interface (HDMI) terminals or Universal Serial Bus (USB) ports.

The wired communication interface 130 may receive video signal or audio signal from external devices.

The memory 140 may store programs for signal processing and control, and store signal-processed video, voice, or data signal.

The memory 140 may perform a function for temporary storage of video, voice, or data signals input from the outside, and may also store information about a certain image through a channel memory function.

The compression chip 150 may compress a video signal or audio signal input from the outside and transmit the compressed signal to the RF transmitting interface 160.

The compression chip 150 may include an encoder for compressing a video signal or an audio signal.

The RF transmitting interface 160 may transmit an A/V signal to the RF receiving interface 240 of the wireless receiving device 200 through RF (Radio Frequency) communication.

The RF transmit interface 160 may include one or more transmitting antennas.

The RF transmitting interface 160 may transmit compressed A/V signal in digital form to the RF receiving interface 240.

The RF transmitting interface 160 may transmit an A/V signal to the RF receiving interface 240 through one or more channels.

The processor 190 may generally control the operation of the wireless transmitting device 100. The processor 190 may be named Main System on Chip (Main SoC).

The processor 190 may also include a compression chip 150.

The wireless receiving device 200 may include a wireless communication interface 210, a wired communication interface 220, an RF receiving interface 240, a memory 250, a display 260, a speaker 270, a decompression chip 280, and a micom (micro-computer, 290).

The wireless communication interface 210 may include a Wi-Fi circuit, a Bluetooth circuit, and an IR circuit.

The Wi-Fi circuit may perform wireless communication through the Wi-Fi standard.

The Wi-Fi circuit may perform wireless communication with an external device or the wireless transmitting device 100 through the Wi-Fi standard.

The Bluetooth circuit may perform wireless communication through the Bluetooth Low Energy (BLE) standard.

The Bluetooth circuit may perform wireless communication with an external device such as a remote control or the wireless transmitting device 100 through the Bluetooth Low Energy (BLE) standard.

The IR circuit may receive a signal from the remote control 300, which will be described later, through IR (Infrared) communication.

The wired communication interface 220 may be an interface for a wired connection with an external device. The wired communication interface 220 may include a plurality of High Definition Multimedia Interface (HDMI) terminals or Universal Serial Bus (USB) ports.

The wired communication interface 220 may receive video signals or audio signals from external devices.

The RF receiving interface 240 may receive a compressed A/V signal from the RF transmitting interface 160.

RF receiving interface 240 may include one or more receive antennas. The RF receiving interface 240 may be placed at the bottom of the display 260.

The RF receiving interface 240 may receive a compressed A/V signal in digital form from the RF transmitting interface 160 and transmit the received A/V signal to the decompression chip 280.

The memory 250 may store programs for signal processing and control, and store signal-processed video, voice, or data signal.

The display 260 may display a video signal received from the micro-computer 290.

The display 260 may display a video signal according to the driving of a timing controller (not shown).

The decompression chip 280 may decompress the compressed A/V signal received by the RF receiving interface 240. The decompression chip 280 may include a decoder and may restore the compressed A/V signal through the decoder.

A micro-computer (micro-computer) 290 may control the overall operation of the wireless receiving device 200.

The micro-computer 290 may output a decompressed video signal through the display 260 and a decompressed audio signal through the speaker 270.

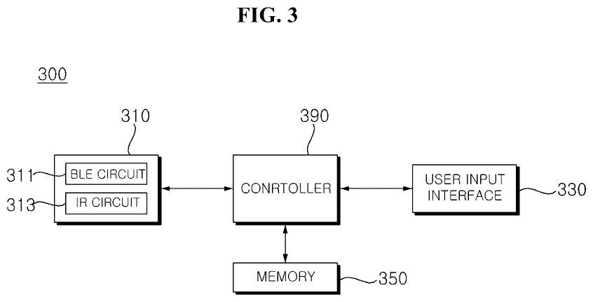

FIG. 3 is a block diagram illustrating the configuration of a remote control device according to an embodiment of the present disclosure.

Referring to FIG. 3, the remote control device 300 may include a wireless communication interface 310, a user input interface 330, a memory 350, and a controller 390.

The wireless communication interface 310 may be an interface for performing wireless communication with the wireless transmitting device 100 or the wireless receiving device 200.

The wireless communication interface 310 may include a Bluetooth Low Energy (BLE) circuit 311 and an InfraRed (IR) circuit 313.

The BLE circuit 311 may transmit a signal for controlling the operation of the wireless transmitting device 100 to the wireless transmitting device 100.

The BLE circuit 311 may transmit a signal that triggers a pairing operation of the wireless transmitting device 100 to the wireless transmitting device 100.

The IR circuit 313 may transmit an IR signal for controlling the operation of the wireless transmitting device 100 or the wireless receiving device 200 to the wireless transmitting device 100.

The user input interface 330 may be comprised of a keypad, button, touch pad, or touch screen.

The user input interface 330 may generate control command for controlling the operation of the wireless transmitting device 100 or the wireless receiving device 200 according to the user's operation command.

If the user input interface 330 is provided with a hard key button, the user may operate the hard key through a push operation of the hard key button.

The user input interface 330 may include various types of input means that the user may operate, such as a scroll key and a jog key.

The memory 350 may store programs for operating the controller 390, and may also temporarily store input/output data.

The controller 390 controls operations related to application programs and generally controls the overall operation of the remote control device 300.

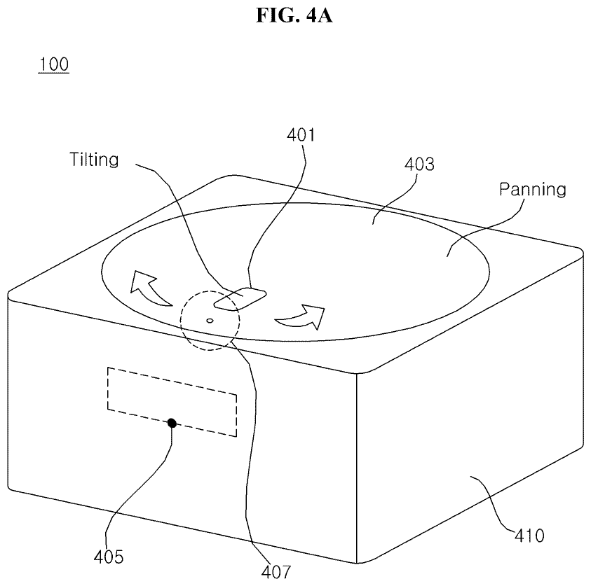

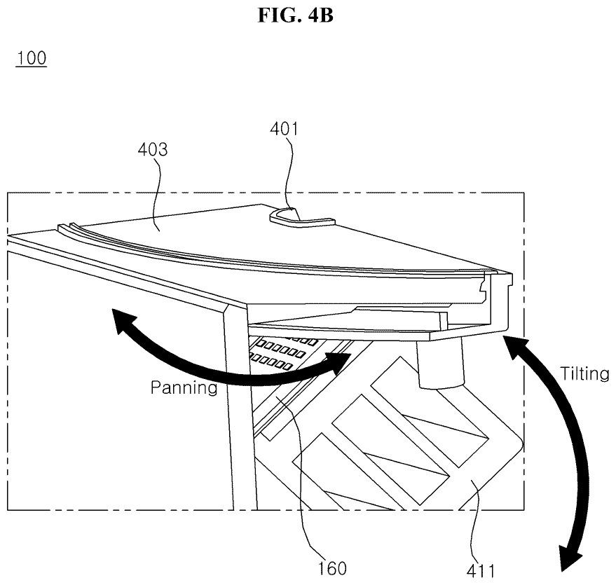

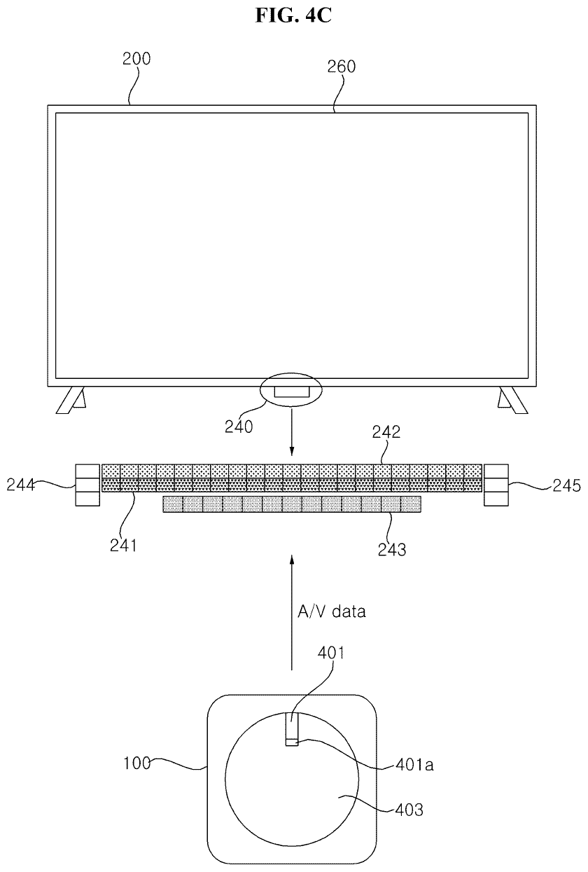

FIG. 4A is a perspective view of a wireless transmitting device, FIG. 4B is a diagram illustrating the internal structure of the wireless transmitting device, and FIG. 4C is a diagram illustrating an RF receiving interface of the wireless receiving device.

Referring to FIG. 4A, the wireless transmitting device 100 may include a box 410, a sliding button housing 401 that accommodates a sliding button 401a, a dial 403, a power status indicator 405, and a communication quality status indicator 407.

The inside of the box 410 may include elements of the wireless transmitting device 100 described in FIG. 2. Box 410 may be a housing that may accommodate elements of the wireless transmitting device 100 described in FIG. 2.

The sliding button 401a may be a means for controlling the vertical direction (tilting control) of the RF transmitting interface 160 shown in FIG. 4B.

The dial 403 may be a means for controlling the horizontal rotation direction (panning control) of the RF transmitting interface 160 shown in FIG. 4B.

The power status indicator 405 may indicate the power on or off state of the wireless transmitting device 100. The power status indicator 405 may include one or more LEDs.

The communication quality status indicator 407 may indicate the communication quality status between the wireless transmitting device 100 and the wireless receiving device 200. Communication quality status indicator 407 may include one or more LEDs.

The communication quality status indicator 407 is an optional configuration and may not be provided in the box 410.

The processor 190 may receive a pointing correction input through the sliding button 401a or the dial 403.

The processor 190 may tilt the RF transmitting interface 160 including the transmitting antennas in the vertical direction according to the input of moving the sliding button 401a.

The RF transmitting interface 160 may include a substrate and a plurality of transmitting antennas. The RF transmitting interface 160 may be provided on the top of the heat sink 611 to release heat generated inside the box 410.

The processor 190 may rotate or pan the RF transmitting interface 160 including the transmitting antennas in the left and right directions according to the input of moving the dial 403.

The user may perform antenna pointing correction by manipulating the sliding button 401a or the dial 403.

Referring to FIG. 4C, an RF receiving interface 240 may be provided at the bottom of the display 260 of the wireless receiving device 200.

RF receiving interface 240 may include a board and a plurality of receiving antennas mounted on the board, and receive A/V data from the wireless transmitting device 100.

The RF receiving interface 240 may be placed at the bottom center of the display 260. The RF receiving interface 240 may be placed in a separate housing, and the housing may be placed at the bottom center of the display 260.

The RF receiving interface 240 may includes a front antenna array 241, an upper antenna array 242 disposed above the front antenna array 241, a lower antenna array 243 disposed below the front antenna array 241, a right antenna array 244 disposed on the right side of the front antenna array 241 and a left antenna array 245 disposed on the left side of the front antenna array 241.

In one embodiment, each of the front antenna array 241, the upper antenna array 242, the lower antenna array 243, the right antenna array 244, and the left antenna array 245 may include a plurality of receiving antennas.

In one embodiment, the receiving antennas included in each of the front antenna array 241, the upper antenna array 242, the lower antenna array 243, the right antenna array 244, and the left antenna array 245 may be arranged to all face the same direction.

In another embodiment, each of the front antenna array 241, the upper antenna array 242, the lower antenna array 243, the right antenna array 244, and the left antenna array 245 may be arranged to face different direction.

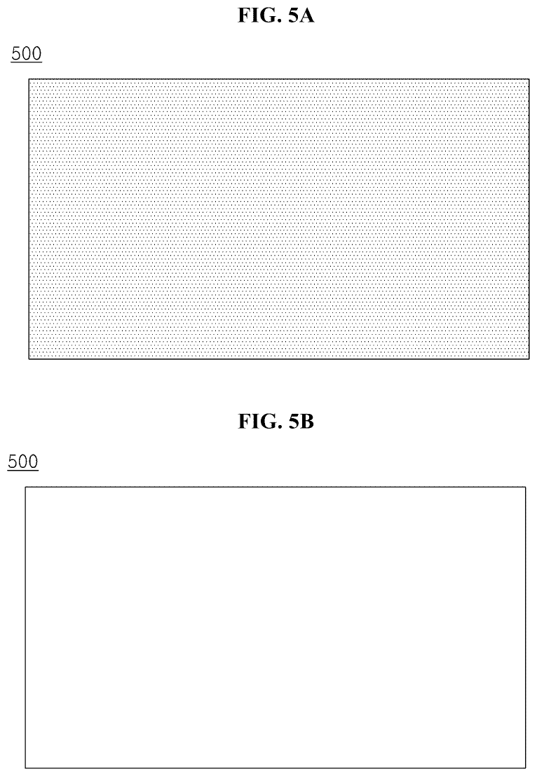

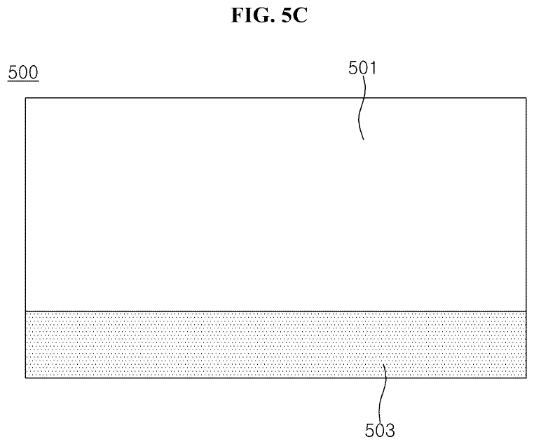

FIGS. 5A to 5C are diagrams illustrating a light blocking state according to an embodiment of the present disclosure.

In one embodiment, the light blocking state of the display 260 may be a state which is determined according to an area of the light blocking area where a light is blocked among the entire area of the display 260. For example, the light blocking state may be any one of a full light blocking state in which the entire area of the display 260 is blocked from the light, a partial light blocking state in which a partial area of the display 260 is blocked from the light, or a non-light blocking state in which the entire area of the display 260 is not blocked from the light.

The full light blocking state may be referred to as a first light blocking state. The partial light blocking state may be referred to as a second light blocking state. The non-light blocking state may be referred to as any one of a transparent state, a light transmitting state, or a third light blocking state.

FIG. 5A may represent the full light blocking state, which indicates a state in which the entire area 500 of the display 260 is light-blocked.

FIG. 5B may show the partial light blocking state in which a first partial area 501 of the entire area 500 of the display 260 is light-transmitted and a second partial area 503 is blocked.

FIG. 5C may represent the non-light blocking state in which the entire area 500 of the display 260 is light-transmitted.

In another embodiment of the present disclosure, the light blocking state of the display 260 may include the degree of light blocking of the entire area of the display 260 or the degree of light blocking of a partial area. The degree of light blocking may be a concept that is inversely proportional to a transparency.

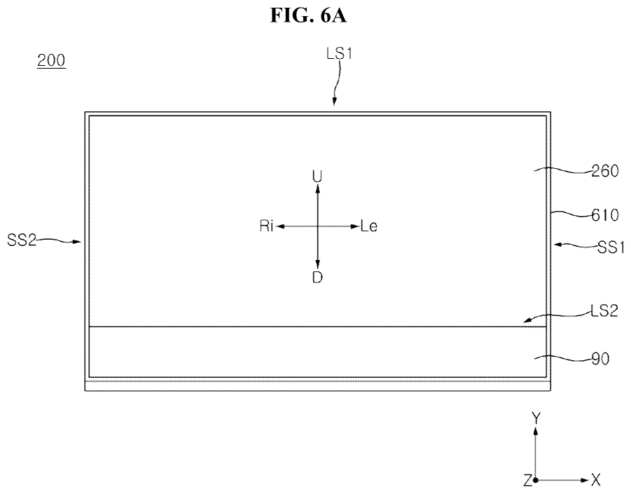

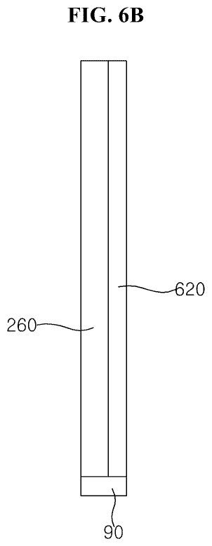

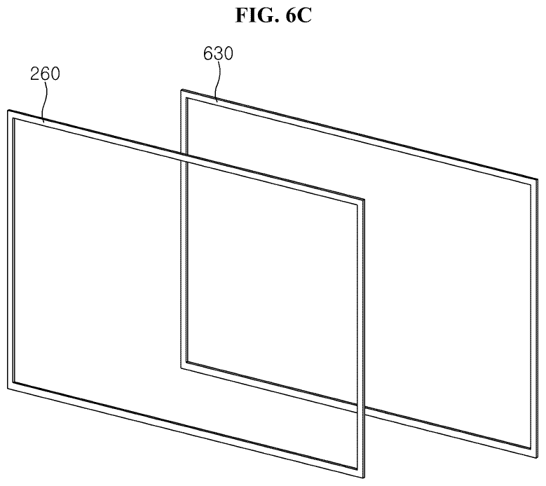

FIGS. 6A and 6B are diagrams illustrating a non-electronic light blocking method according to an embodiment of the present disclosure, and FIG. 6C is a diagram illustrating an electronic light blocking method according to another embodiment of the present disclosure.

The light blocking state of the display 260 may be controlled through a non-electronic light blocking method or an electronic light blocking method.

In one embodiment, a light blocking film may be provided on one side of the display 260. The light blocking film may block light transmitted to the area of the display 260.

The light blocking film may be either the light blocking film of a first type or the light blocking film of a second type. The light blocking film of the first type may be a non-electronic light blocking film, and the light blocking film of second type may be an electronic light blocking film.

The light blocking film of the first type may be made of any one of a polymer film, an opaque film, and a fiber film made of fiber, but this is only an example.

The light blocking film of the second type may be an electronic light blocking film such as a Liquid Crystal Display (LCD) panel.

In the case of the non-electronic light blocking method, the size of the light blocking area of the display 260 may be adjusted according to a physical movement of the light blocking film of the first type.

In the case of the electronic light blocking method, a transmittance of the area of the display 260 is electrically controlled, so that the light blocking state of the display 260 may be adjusted. The electronic light blocking method may be referred to as a liquid crystal shutter method.

First, the non-electronic light blocking method is explained.

Referring to FIG. 6A, the wireless receiving device 200 may include a display 260, a side frame 610, and a housing 90. The display 260 may display an image. The side frame 610 may extend along a perimeter of the display 260. The housing 90 may be located below the display 260 and the side frame 610. Alternatively, the housing 90 may be located on a upper side, a left side, or a lower side the display 260 and the side frame 610.

The display 260 may include a first long side (LS1), a second long side (LS2) opposing the first long side (LS1), a first short side SS1 adjacent to the first long side (LS1) and a second long side LS2 and a second short side (SS2) opposite to the first short side (SS1).

Meanwhile, for convenience of explanation, a length of the first and second long sides LS1 and LS2 is shown and described as being longer than a length of the first and second short sides SS1 and SS2, it may be possible that the length of the first and second long sides LS1 and LS2 is approximately the same as or longer than the length of the first and second short sides (SS1, SS2).

A direction parallel to the long sides LS1 and LS2 of the display 260 may be referred to as a left and right direction. The direction parallel to the short sides SS1, SS2 of the display 260 may be referred to as a vertical direction. The direction perpendicular to the long sides (LS1, LS2) and short sides (SS1, SS2) of the display 260 may be referred to as a front-back direction.

The direction in which the display 260 displays the image may be referred to as a front (z), and the opposite direction may be referred to as a rear (−z). The first short side (SS1) may be referred to as a left side (x, Le). The second short side (SS2) may be called a right side (−x, Ri). The first long side (LS1) may be called a upper side (y, U). The second long side (LS2) may be called a lower side (−y, D).

The interior of the housing 90 may be provided with the light blocking film, one or more rollers that move the light blocking film upward, and one or more motors that drive the one or more rollers.

The first type of light blocking film may be located behind the rear surface of the display 260 and may be moved in the vertical direction of the display 260. The first type of light blocking film may have an area that may cover the back of the display 260.

The light blocking film of the first type may be placed on the upper surface of the display 260, has the shape of a curtain slide, and may be moved up and down.

The micro-computer 290 of the wireless receiving device 200 may control the movement of the light blocking film of the first type by controlling one or more motors provided inside the housing 90.

Referring to FIG. 6B, a light blocking film of the first type 620 covering the rear surface of the display 260 is shown. The light blocking film of the first type 620 may be pulled out or retracted from the housing 90.

In FIG. 6B, the light blocking state of the display 260 may be the full light blocking state.

Next, the electronic light blocking method will be described with reference to FIG. 6C.

Referring to FIG. 6C, the display 260 and the light blocking film of the second type 630 disposed behind the display 260 are shown. The light blocking film of the second type 630 may be a liquid crystal display (LCD) panel.

The micro-computer 290 of the wireless receiving device 200 may control the LCD panel 630 to control the transmittance corresponding to the partial area or the entire area of the display 260.

The micro-computer 290 or an image driving circuit (not shown) may transmit a control signal that controls an arrangement of liquid crystal molecules corresponding to the area of the display 260 to the LCD panel 630, thereby adjusting the transmittance for the corresponding area. The image driving circuit may be included in the micro-computer 290 or may be an element provided separately from the micro-computer 290.

The control signal that controls the arrangement of liquid crystal molecules may be a voltage signal that controls the voltage applied to a liquid crystal layer of the LCD panel 630.

The LCD panel 630 may include two polarizing plate, a thin film transistor (TFT), and the liquid crystal layer. Each of the two polarizers may transmit a light in one direction and block the light in the other direction. The TFT may be a switching device that applies and blocks a voltage signal that controls the arrangement of liquid crystal molecules to the liquid crystal layer. The Liquid crystal molecules in the liquid crystal layer may be aligned according to the voltage signal received from the TFT. The light may be passed or blocked according to the arrangement of the liquid crystal molecules.

The Light may pass through a first polarizing plate and then pass through the liquid crystal layer. When the polarization direction of the light changes in the liquid crystal layer, it may pass through a second polarizing plate. If the polarization direction of the light changes according to the arrangement of the liquid crystal, an amount of the light passing through the second polarizing plate may vary. Because of this, the transmittance of the LCD panel 630 may be adjusted.

The image driving circuit may adjust the transmittance of a specific area by applying or blocking a voltage only to pixels of the specific area through electrodes arranged in a matrix form on the LCD panel 630.

The wireless receiving device 200 may adjust the transmittance of the specific area of the display 260 to generate a light blocking area and a non-light blocking area.

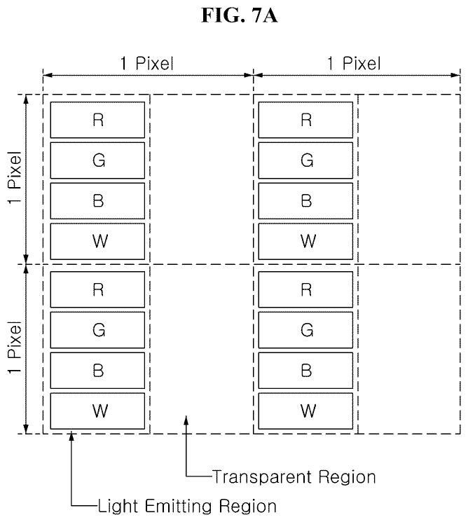

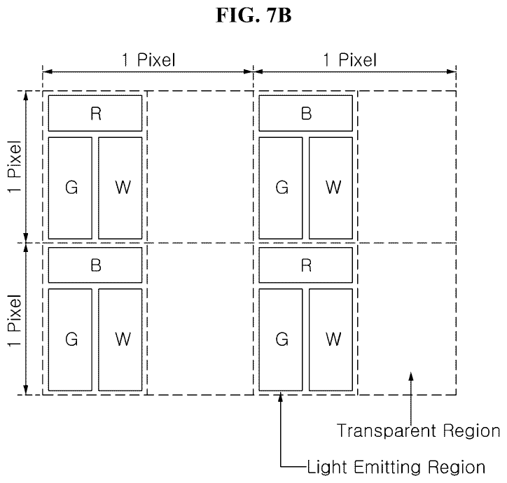

FIGS. 7A and 7B are diagrams illustrating various types of display according to embodiments of the present disclosure.

Referring to FIG. 7A, a pixel may include a light emitting region and a transparent region. In the light-emitting area, subpixels of RGBW (Red, Green, Blue, White) may be arranged vertically, and the light-emitting area without subpixels may be placed next to the light-emitting area.

Accordingly, the display 260 having a plurality of pixels may not only display an image but also transmit a light. The display 260 may be referred to as a transparent display panel or a transparent OLED (Organic Light Emitting Diode) panel.

Referring to FIG. 7B, a pixel may include a light emitting region and a transparent region. In the light-emitting area, subpixels of RGW (Red, Green, White) or BGW (Blue, Green, White) may be arranged adjacent to each other, and the light-emitting area without subpixels is next to the light-emitting area.

Accordingly, the display 260 having the plurality of pixels may not only display the image but also transmit the light. The display 260 may be referred to as a transparent display panel or a transparent OLED panel.

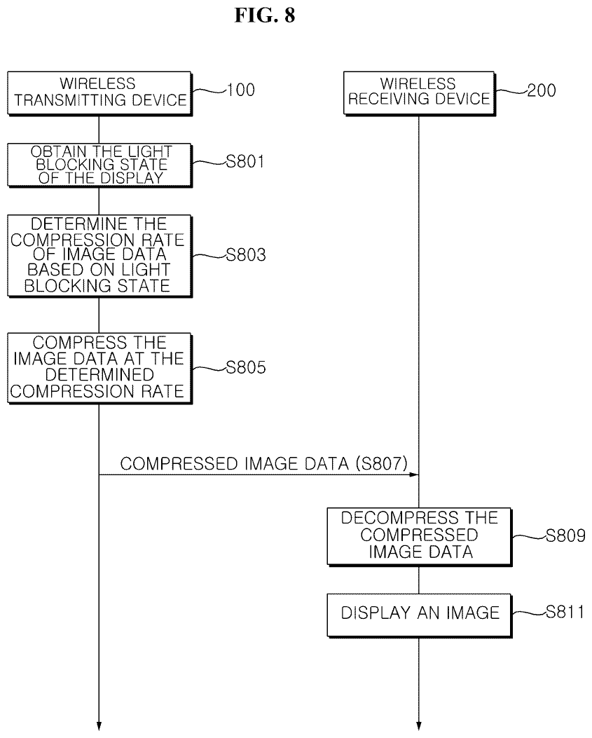

FIG. 8 is a sequence diagram for illustrating a method of operating a wireless display system according to an embodiment of the present disclosure.

Hereinafter, the compression rate may be a size ratio of a original data and a compressed data. The compression rate may be calculated as follows.

Compression rate=a size of the original data/a size of the compressed data

The display 260 is explained by taking a display panel using an organic light emitting diode (OLED) as an example, but the display panel applicable to the present disclosure is not limited to this.

Referring to FIG. 8, the processor 190 of the wireless transmitting device 100 may obtain the light blocking state of the display 260 provided in the wireless receiving device 200 (S801).

The processor 190 may receive information about the light blocking state of the display 260 from the wireless receiving device 200. The processor 190 may receive information about the light blocking state of the display 260 from the wireless receiving device 200 through the wireless communication interface 120. Specifically, the processor 190 may obtain information about the light blocking state of the display 260 from the wireless receiving device 200 through a BLE communication.

The information about the light blocking state may include information indicating that the display 260 operates in one of the fully light blocking state, the partial light blocking state, or the non-light blocking state.

The micro-computer 290 of the wireless receiving device 200 may obtain information about the light blocking state of the display 260 and transmit the obtained information about the light blocking state to the wireless transmitting device 100. The micro-computer 290 may obtain the information about the light blocking state of the display 260 periodically or in real time.

The processor 190 of the wireless transmitting device 100 may determine the compression rate of image data based on the obtained light blocking state of the display 260 (S803).

In one embodiment, when the light blocking state of the display 260 is in the full light blocking state, the processor 190 may determine the compression rate of the image data as a first compression rate. The first compression rate may have a value in the range of 4 to 8, but this is only an example.

When the light blocking state of the display 260 is the full light blocking state, the processor 190 may determine that the viewer wants to focus on the image and lower the compression rate of the image data in order to output a high-resolution image.

When the light blocking state of the display 260 is the non-light blocking state, the processor 190 may determine the compression rate of the image data to be a second compression rate that is greater than the first compression rate. The second compression rate may have a value in the range of 10 to 20, but this is only an example.

When the light blocking state of the display 260 is the non-light blocking state, the viewer's viewing intention may be understood as an intention to focus less on the image. The processor 190 may determine the compression rate of the image data to be greater than the first compression rate in order to output the image with a lower resolution than a high-resolution image.

When the light blocking state of the display 260 changes from the full light blocking state to the non-light blocking state, the processor 190 may adjust the compression rate of the image data from the first compression rate to the second compression rate.

When the compression rate of the image data is adjusted from the first compression rate to the second compression rate as the light blocking state of the display 260 changes from the full light blocking state to the non-light blocking state, the size of the image data transmitted to the wireless receiving device 200 may be decreased.

As the size of the image data is reduced, the image data may be stably transmitted to the wireless receiving device 200 even in a wireless failure environment. Additionally, as the size of image data decreases, the number of antennas used for transmitting and receiving data may be reduced, and thus the power consumption required for antenna operation may be reduced.

In one embodiment, when the light blocking state of the display 260 is the partial light blocking state, the processor 190 may determine compression rates for the light blocking area and the non-light blocking area of the display 260 to be different from each other. For example, the processor 190 may determine the compression rate of a first image data displayed on the light blocking area of the display 260 as the first compression rate, and determine the compression rate of a second image data displayed on the non-light blocking area of the display 260 as the second compression rate.

Meanwhile, the light blocking area may be referred to as an opaque area, and the non-light blocking area may also be referred to as a transparent area.

Meanwhile, in another embodiment of the present disclosure, the processor 190 may increase the compression rate of the image data to a preset compression rate or a third compression rate that is higher than the second compression rate while the light blocking state of the display 260 is changed (for example, while the light blocking film 91 is moved).

The processor 190 of the wireless transmitting device 100 may compress the image data at the determined compression rate through the compression chip 150 (S805).

The processor 190 of the wireless transmitting device 100 may transmit compressed image data to the wireless receiving device 200 through the RF transmitting interface 160 (S807).

The micro-computer 290 of the wireless receiving device 200 may decompress the compressed image data through the decompression chip 280 (S809).

The micro-computer 290 of the wireless receiving device 200 may display an image based on the decompressed image data on the display 260 (S811).

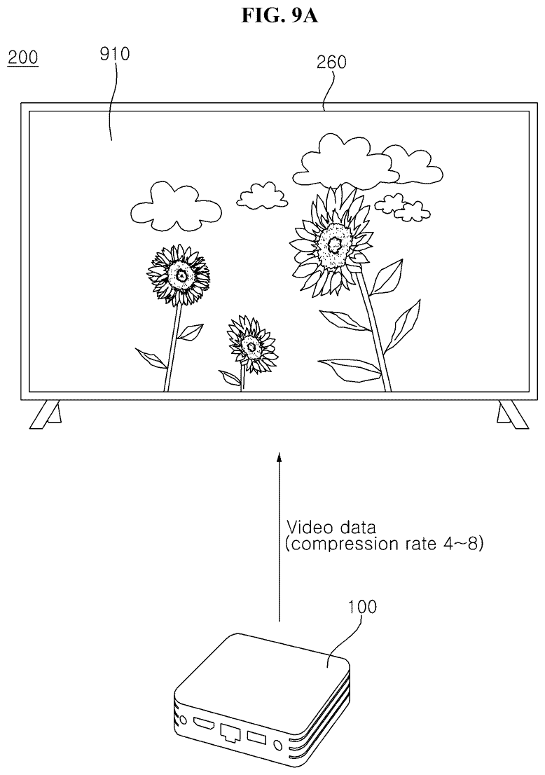

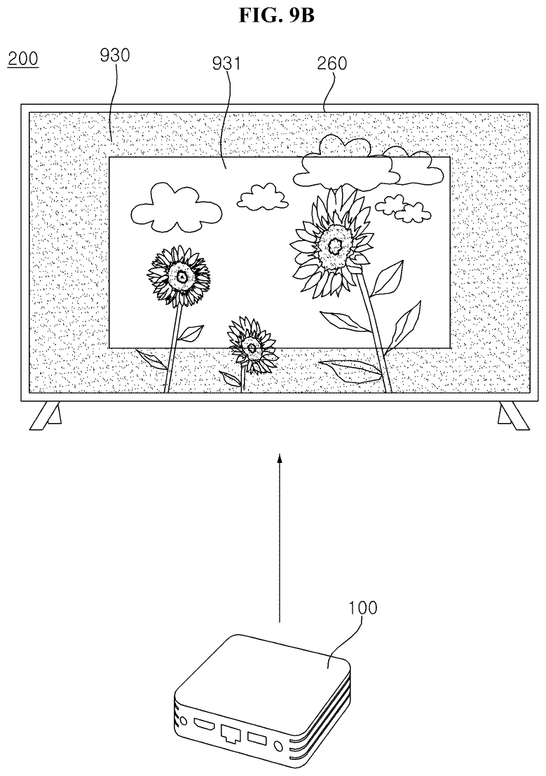

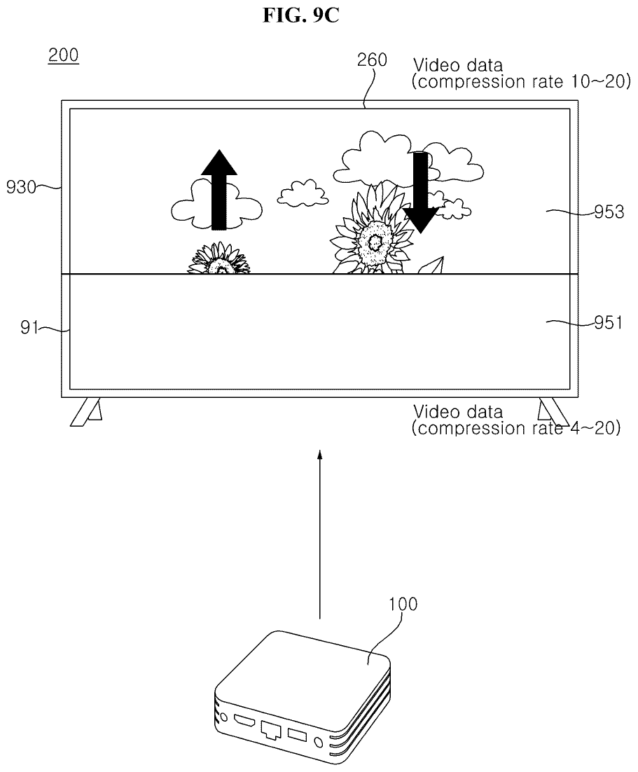

FIGS. 9A to 9C are diagrams illustrating a method of controlling the compression rate of image data according to the operation of the non-electronic light blocking method according to an embodiment of the present disclosure.

The wireless receiving device 200 may obtain the light blocking state of the display 260 based on a extraction distance of the light blocking film provided in the housing 90. When the light blocking film is extended beyond the first short side to the first long side of the display 260, the wireless receiving device 200 may obtain the light blocking state of the display 260 as the full light blocking state. When the light blocking film is not pulled out from the housing 90, the wireless receiving device 200 may obtain the light blocking state of the display 260 as the non-light blocking state.

The wireless receiving device 200 may obtain the light blocking state of the display 260 as the partial light blocking state when the light blocking film is extended a certain distance or more from the first long side of the display 260 but less than the first short side. When the light blocking state of the display 260 is the partial light blocking state, the wireless receiving device 200 may transmit, to the wireless transmitting device 100, the information about the light blocking state, including a light blocking coordinate indicating the light blocking area of the display 260 and the partial light blocking state.

The wireless transmitting device 100 may identify the light blocking area and the non-light blocking area of the display 260 based on the light blocking coordinate and the partial light blocking state.

In FIG. 9A, the light blocking state of the display 260 may be in the full light blocking state in which the light blocking film provided on the housing 90 blocks light from the entire area of the display 260. When the light blocking state of the display 260 is determined to be the full light blocking state, the wireless transmitting device 100 may transmit a high-resolution image data with a first compression rate (within the range of 4 to 8) to the wireless receiving device 200.

In FIG. 9B, the light blocking state of the display 260 may be in the non-light blocking state in which the light blocking film provided in the housing 90 is not pulled out. When the light blocking state of the display 260 is determined to be the non-light blocking state, the wireless transmitting device 100 may transmit a low resolution image data with a second compression rate (within the range of 10 to 20) to the wireless receiving device 200.

When the light blocking state of the display 260 is in the non-light blocking state, the entire area of the display 260 may be in a light transmitting state. Therefore, a background on the back of the display 260 may be exposed while displaying a low resolution image 931.

As such, according to an embodiment of the present disclosure, when the light blocking film 91 blocks light from the entire area of the display 260, the wireless transmitting device 100 may reduce the compression rate of the image data enabling the viewer to watch a high-quality image. In addition, according to an embodiment of the present disclosure, when the light blocking film 91 does not block the entire area of the display 260, the wireless transmitting device 100 may increase the compression rate of image data to reduce power consumption of the wireless display system and respond appropriately to wireless connection failure environment.

In FIG. 9C, the light blocking state of the display 260 may be in the partial light blocking state in which the light blocking film 91 provided in the housing 90 is partially drawn out. When the light blocking state of the display 260 is determined as the partial light blocking state, the wireless transmitting device 100 may transmit, to the wireless receiving device 200, a first image data of a high-resolution having a first compression rate (within the range of 4 to 8) and a second image data of a low resolution having a second compression rate (within a range of 10 to 20).

The wireless transmitting device 100 may receive information about the light blocking state including light blocking coordinate indicating the light blocking area 951 and the partial light blocking state from the wireless receiving device 200.

The wireless transmitting device 100 may identify the light blocking area 951 using the light blocking coordinate, and compress the first image data corresponding to the first image to be displayed in the identified light blocking area 951 at the first compression rate. The wireless transmitting device 100 may compress the second image data corresponding to the second image to be displayed in the non-light blocking area 953 other than the light blocking area 951 at the second compression rate.

The wireless transmitting device 100 may transmit the first image data with the first compression rate and the second image data with the second compression rate to the wireless receiving device 200. The wireless receiving device 200 may restore the first image data to display the first image based on the restored first image data on the light blocking area 951 of the display 260, and restore the second image data to display a second image based on the second image data on the non-light blocking area 953 of the display 260.

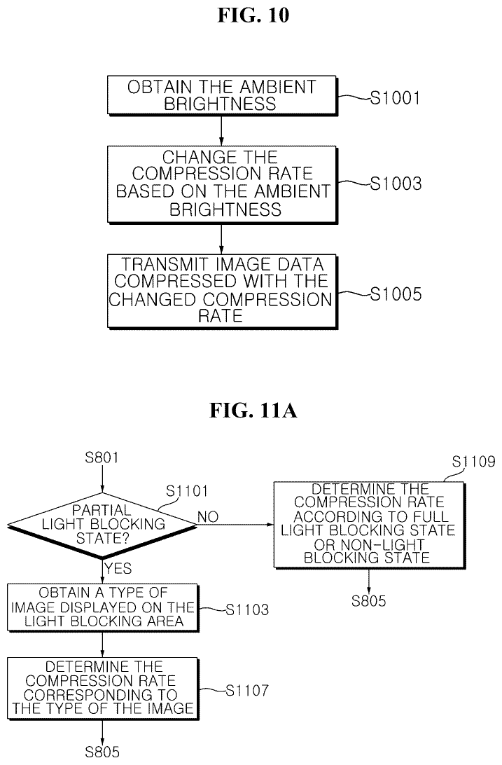

FIG. 10 is a diagram illustrating a process for determining the compression rate based on the light blocking state and the ambient brightness of the display according to another embodiment of the present disclosure.

FIG. 10 may be an operation performed after step S803 of FIG. 8.

The processor 190 of the wireless transmitting device 100 may determine the compression rate of the image data based on the light blocking state (S803) and then obtain the ambient brightness of the display 260 (S1001).

The processor 190 may obtain information about the ambient brightness of the display 260 from the wireless receiving device 200. The wireless receiving device 200 may include an illumination sensor disposed on one side of the display 260. The illuminance sensor may measure a resistance value that change according to an intensity of a light, and convert the measured resistance value into an ambient brightness value.

The wireless receiving device 200 may transmit the ambient brightness value measured through the illuminance sensor to the wireless transmitting device 100 through the wireless communication interface 210.

The processor 190 may change the compression rate determined based on the ambient brightness of the display 260 (S1003) and transmit image data compressed with the changed compression rate to the wireless receiving device 200 (S1005).

In one embodiment, the processor 190 may change the compression rate primarily determined according to the light blocking state of the display 260 by considering the ambient brightness. For example, the processor 190 may decrease the determined compression rate as the ambient brightness value received from the wireless receiving device 200 becomes larger (brighter), and increase the determined compression rate as the ambient brightness value becomes smaller (darker).

The memory 140 of the wireless transmitting device 100 may store a lookup table representing a correspondence between the ambient brightness value and the adjustment degree of the compression rate matching the ambient brightness value. The processor 190 may extract the adjustment degree of the compression rate that matches the ambient brightness value through the lookup table stored in the memory 140 and change the compression rate based on the extracted the adjustment degree of the compression rate.

Accordingly, when the surrounding environment of the display 260 becomes brighter, the compression rate of the image is lowered, allowing the viewer to watch a high-resolution image. Additionally, when the surrounding environment of the display 260 becomes dark, the compression rate of the image increases, so that image data may be transmitted without interruption even in a wireless failure environment.

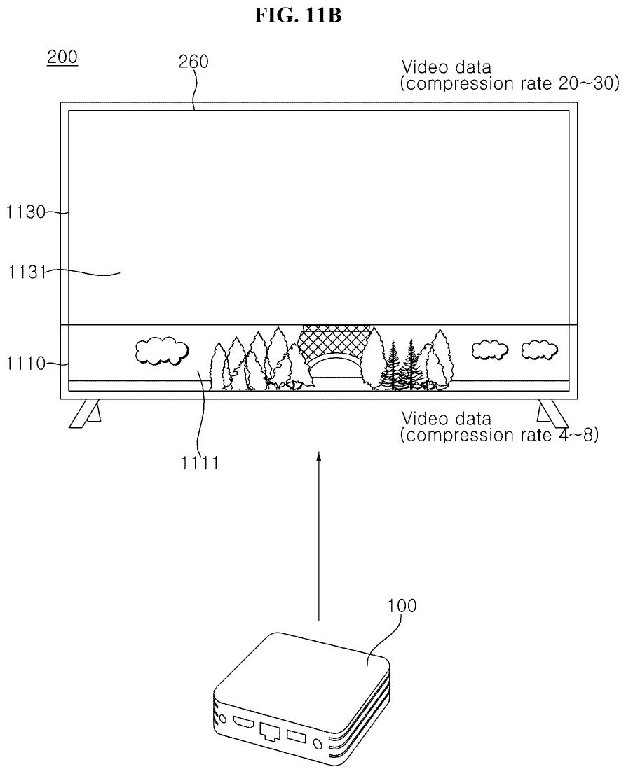

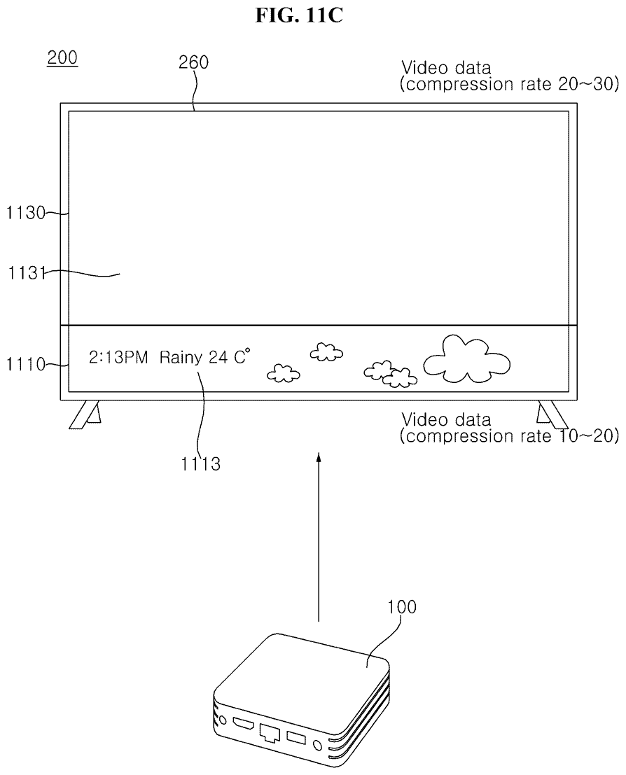

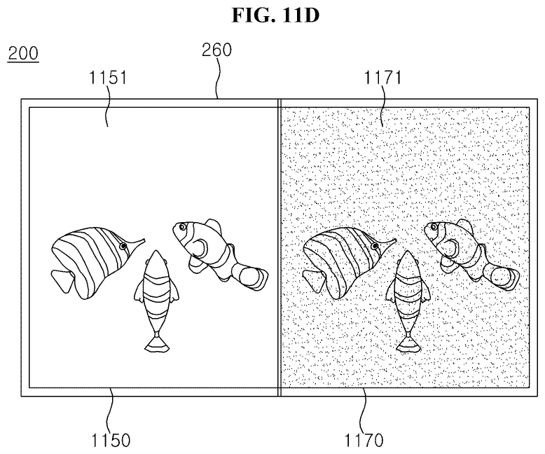

FIGS. 11A to 11D are diagrams illustrating an example of determining the compression rate of image data based on the type of image displayed in the light blocking area according to an embodiment of the present disclosure.

FIGS. 11A to 11D, the light blocking method of the display 260 may be either a non-electronic light blocking method or an electronic light blocking method.

The processor 190 of the wireless transmitting device 100 may determine whether the light blocking state of the display 260 is the partial light blocking state (S1101).

If the light blocking state of the display 260 is determined to be the partial light blocking state, the processor 190 may obtain a type of image displayed on the light blocking area (S1103).

In one embodiment, the type of image may be either a content image type or an information video type. The content image type may be a type representing any one of a broadcast program, content provided by a content provider, or a moving image provided by a moving image streaming service.

The information video type may be a type that provides basic information such as a weather, a time, and a schedule.

The type of image to be displayed in the light blocking area may be changed according to a user setting. The processor 190 may determine the type of image to be displayed in the light blocking area based on user setting information.

The processor 190 may determine the compression rate corresponding to the obtained type of the image (S1107).

When the type of image is the content image type, the processor 190 may determine the compression rate of the image data as a first compression rate, and when the type of the image is the information image type, the processor 190 may determine the compression rate of the image data as a second compression rate higher than the first compression rate.

That is, when the content image is displayed in the light blocking area, an image quality may be improved by lowering the compression rate of the image data, and when the information image is displayed in the light blocking area, a wireless transmission quality may be improved by increasing the compression rate of the image data.

If the type of image displayed in the light blocking area is the content image type, the processor 190 may compress an image data corresponding to the content image at the first compression rate and transmit the compressed image data to the wireless receiving device 200. The wireless receiving device 200 may restore the compressed image data to display the restored content image on the light blocking area of the display 260.

When the type of image displayed in the light blocking area is the information image type, the processor 190 may compress an image data corresponding to the information image at the second compression rate and transmit the compressed image data to the wireless receiving device 200. The wireless receiving device 200 may restore compressed image data to display the restored information image on the light blocking area of the display 260.

Meanwhile, the processor 190 may determine the compression rate of image data corresponding to the image displayed in the non-light blocking area of the display 260 to be a third compression rate that is higher than the second compression rate. The processor 190 may compress image data corresponding to an image to be displayed in the non-light blocking area at a third compression rate and transmit the compressed image data to the wireless receiving device 200. The wireless receiving device 200 may restore the compressed image data to display the restored image on the non-light blocking area of the display 260.

When the light blocking state of the display 260 is the full light blocking state or the non-light blocking state, the processor 190 may determine the compression rate of the image data according to the light blocking state (S1109). This will be replaced with the description of step S803 in FIG. 8.

FIGS. 11B and 11C, the entire area of the display 260 may be divided into a light blocking area 1110 and a non-light blocking area 1130. The light blocking area 1110 may be an area that is blocked from light by physically moving the light blocking film 91 or using an electronic light blocking method. The non-light blocking area 1130 may be a transparent area that is not light blocked.

The light blocking area 1110 may be a temporarily blocked area or a permanently blocked area.

FIG. 11B is explained assuming that the image to be displayed on the light blocking area 1110 of the display 260 is the content image type.

The wireless transmitting device 100 may determine the compression rate of a content image 1111 as the first compression rate and compress content image data corresponding to the content image 1111 at the determined first compression rate.

The wireless transmitting device 100 may transmit content image data compressed at the first compression rate to the wireless receiving device 200. The wireless transmitting device 100 may transmit coordinate information indicating the location of the light blocking area 1110 to the wireless receiving device 200 along with the compressed content image data.

The wireless receiving device 200 may display the content image 1111 on the light blocking area 1110 of the display 260 based on the received coordinate information and the compressed content image data.

FIG. 11C is explained assuming that the image to be displayed on the light blocking area 1110 of the display 260 is the information image type.

The wireless transmitting device 100 may determine the compression rate of an information image 1113 to be a second compression rate that is higher than the first compression rate, and compress information image data corresponding to the information image 1113 at the determined second compression rate.

The wireless transmitting device 100 may transmit information image data compressed at the second compression rate to the wireless receiving device 200. The wireless transmitting device 100 may transmit coordinate information indicating the location of the light blocking area 1110 to the wireless receiving device 200 along with the compressed information image data.

The wireless receiving device 200 may display the information image 1113 on the light blocking area 1110 of the display 260 based on the received coordinate information and the compressed information image data.

Meanwhile, no image may be displayed in the non-light blocking area 1130 in FIGS. 11B and 11C. Accordingly, the background behind the display 260 may be exposed through the non-light blocking area 1130.

In another embodiment, in FIGS. 11B and 11C, the wireless transmitting device 100 may compress non-light blocking image data to be displayed on the non-light blocking area at a third compression rate higher than the second compression rate, and transmit the compressed non-light blocking image data to the wireless receiving device 200. At the same time, the wireless transmitting device 100 may transmit coordinate information indicating the location of the non-light blocking area to the wireless receiving device 200 along with the non-light blocking image data compressed at the third compression rate.

The wireless receiving device 200 may display a non-blocking image 1131 on the non-blocking area 1130 of the display 260 based on the received coordinate information and the compressed non-blocking image data.

As such, according to an embodiment of the present disclosure, when the content image is displayed in the light blocking area, the image quality may be improved by lowering the compression rate of the image data, and when the information image is displayed in the light blocking area, the compression rate of the image data may be increased to improve the wireless transmission quality may be improved.

Additionally, according to an embodiment of the present disclosure, the image quality may be improved by lowering the compression rate of an image corresponding to the light blocking area, and the wireless transmission quality may be improved by increasing the compression rate of an image corresponding to the non-light blocking area.

FIG. 11D is a diagram illustrating a case where a light blocking area 1150 and a non-light blocking area 1170 of the display 260 have the same area. A first image 1151 based on first image data compressed at the first compression rate may be displayed on the light blocking area 1150, and a second image 1171 based on second image data compressed at the second compression rate may be displayed on the non-light blocking area 1170.

When the electronic light blocking method is used in FIG. 11D, the micro-computer 290 of the wireless receiving device 200 may control the LCD panel 630 disposed on the rear of the display 260 to adjust the transmittance of each area of the display 260. Accordingly, the entire area of the display 260 may be classified into the light blocking area 1150 and the non-light blocking area 1170.

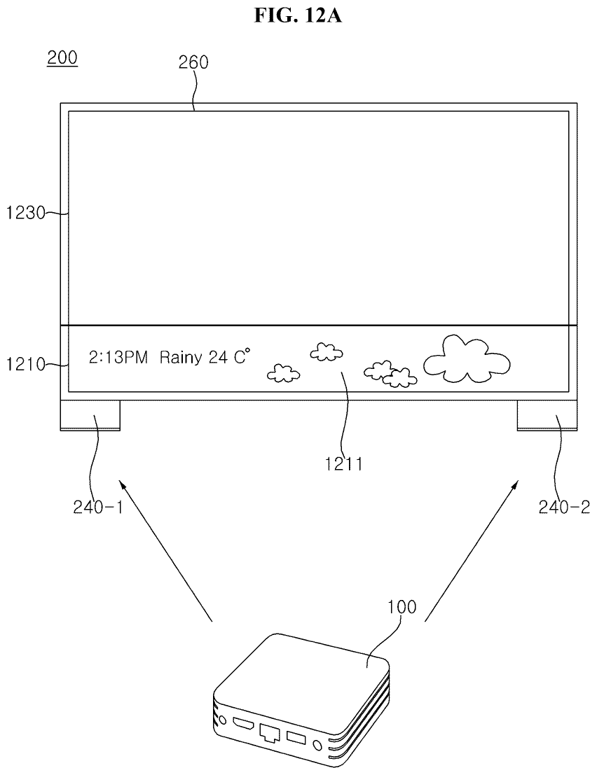

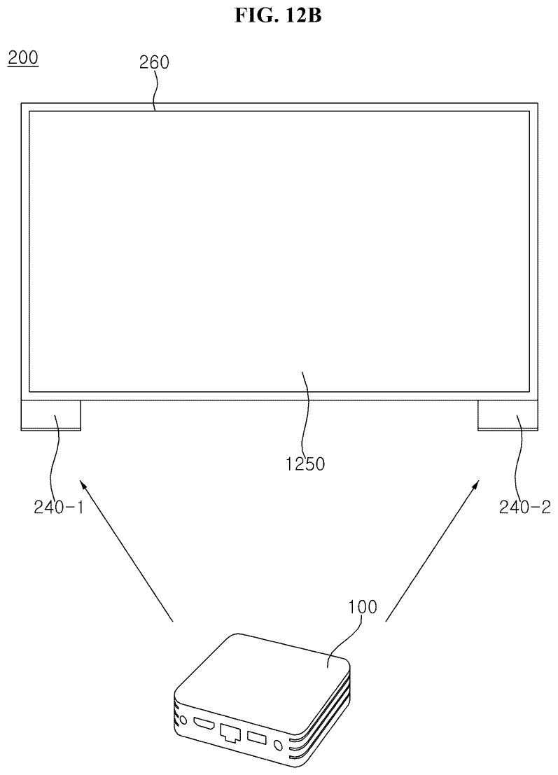

FIGS. 12A and 12B are diagrams illustrating an embodiment of selectively operating a plurality of RF receiving interfaces according to the light blocking state of the display when the wireless receiving device is equipped with the plurality of RF receiving interfaces.

The wireless receiving device 100 may include a first RF receiving interface 240-1 disposed on one side of the bottom of the display 260, and a second RF receiving interface 240-2 located at a certain distance in the direction extending along the long side of the display 260 from the first RF receiving interface 240-1.

Each of the first RF receiving interface 240-1 and the second RF receiving interface 240-2 may have the same function and structure as the RF receiving interface 240 shown in FIG. 4C.

In FIG. 12A, the entire area of the display 260 may include a light blocking area 1210 and a non-light blocking area 1230. The non-light blocking area 1230 is a transparent area, and no image may be displayed. That is, the wireless transmitting device 100 may transmit compressed image data so that the image is displayed only in the light blocking area 1210 of the display 260.

It is assumed that the image displayed in the light blocking area 1210 is an information image 1211.

When the light blocking state of the display 260 is the partial light blocking state, the processor 190 of the wireless transmitting device 100 may wirelessly select an interface with better performance among the first RF receiving interface 240-1 and the second RF receiving interface 240-2.

The processor 190 may obtain a first wireless quality indicator between the RF transmitting interface 160 and the first RF receiving interface 240-1 and a second wireless quality indicator between the RF transmitting interface 160 and the second RF receiving interface 240-2.

The wireless quality indicator may be either a Received Signal Strength Indicator (RSSI) or a Signal to Noise Ratio (SNR).

If the light blocking state of the display 260 is the partial light blocking state and the first wireless quality indicator is greater than the second wireless quality indicator, the processor 190 may transmit, to the first RF receiving interface 240-1, compressed image data corresponding information image 1211 through the RF transmitting interface 160. To this end, the processor 190 may transmit an off command to the wireless receiving device 200 to turn off the operation of a plurality of receiving antennas provided in the second RF receiving interface 240-2. The off command may be transmitted to the wireless receiving device 200 through BLE communication.

Accordingly, when the light blocking state of the display 260 is the partial light blocking state, a power consumption can be reduced while maintaining wireless quality by selectively operating either the first RF receiving interface 240-1 or the second RF receiving interface 240-2.

In FIG. 12B, the light blocking state of the display 260 may be in the non-light blocking state.

When the light blocking state of the display 260 is in the non-light blocking state, the processor 190 of the wireless transmitting device 100 wirelessly select an interface with better performance among the first RF receiving interface 240-1 and the second RF receiving interface 240-2.

The processor 190 may obtain a first wireless quality indicator between the RF transmitting interface 160 and the first RF receiving interface 240-1 and a second wireless quality indicator between the RF transmitting interface 160 and the second RF receiving interface 240-2.

If the light blocking state of the display 260 is in the non-light blocking state and the first wireless quality indicator is greater than the second wireless quality indicator, the processor 190 may transmit, to the first RF receiving interface 240-1, compressed image data corresponding to the image 1250 through the RF transmitting interface 160. To this end, the processor 190 may transmit an off command to the wireless receiving device 200 to turn off the operation of a plurality of receiving antennas provided in the second RF receiving interface 240-2. The off command may be transmitted to the wireless receiving device 200 through BLE communication.

Accordingly, when the light blocking state of the display 260 is in the non-light blocking state, a power consumption can be reduced while maintaining wireless quality by selectively operating either the first RF receiving interface 240-1 or the second RF receiving interface 240-2.

Meanwhile, in another embodiment of the present disclosure, the processor 190 may transmit an on command to the wireless receiving device 200 to turn on the operation of the second RF receiving interface (240-2) if the display (260) is in the partial light blocking state or the non-light blocking state, and the first wireless quality indicator falls below a predetermined threshold while image data is being transmitted through the first RF receiving interface 240-1.

Accordingly, even if the wireless quality indicator with the first RF receiving interface 240-1 falls (for example, if an obstacle exists between the first RF receiving interface and the wireless transmitting device), the second RF receiving interface 240-1 is immediately operated, thereby quickly overcome the wireless failure environment.

According to another embodiment of the present disclosure, when the light blocking state of the display 260 is in the non-light blocking state, the wireless transmitting device 100 may adjust the compression rate of image data based on the transparency of the non-light blocking area. The transparency may correspond to the degree of light blocking. As the transparency increases, the degree of light blocking may decrease, and as the transparency decreases, the degree of light blocking may increase.

To this end, the wireless transmitting device 100 may store a lookup table representing the correspondence between the transparency and the compression rate in the memory 140.

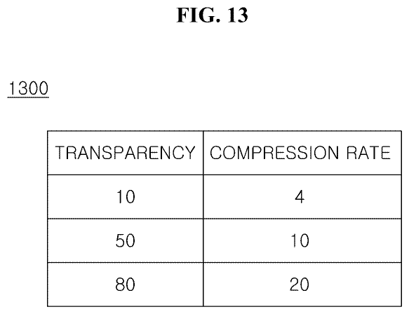

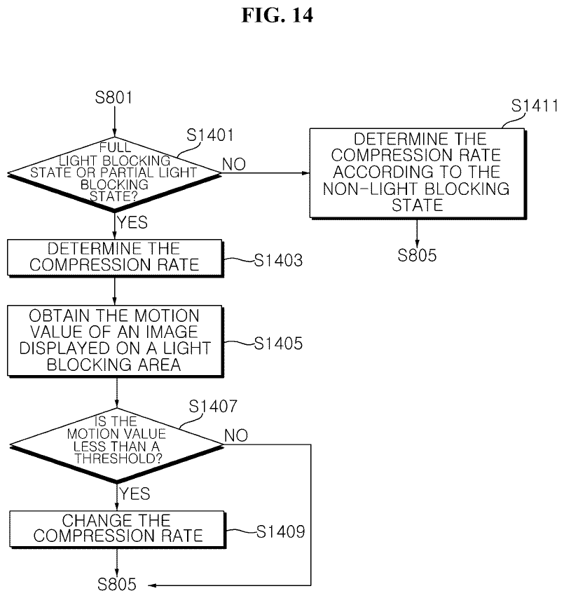

FIG. 13 is a diagram illustrating a lookup table showing the correspondence between transparency and compression rate.

The memory 140 of the wireless transmitting device 100 may store a lookup table 1300 that represents the correspondence between the transparency and the compression rate of the area of the display 260. As the transparency increases, the compression rate may also increase, and as the transparency decreases, the compression rate may also decrease.

Under the electronic light blocking method, the transparency of a specific area of the display 260 may be adjusted. The wireless transmitting device 100 may receive information about the transparency of the entire area or a partial area of the display 260 from the wireless receiving device 200.

The wireless transmitting device 100 may extract the compression rate corresponding to the transparency of the area from the look-up table 1300 based on the received transparency information.

When the transparency of a first area of the display 260 is 10, the wireless transmitting device 100 may determine the compression rate of the first image to be displayed on the first area to be 4. When the transparency of a second area of the display 260 is 50, the wireless transmitting device 100 may determine the compression rate of the second image to be displayed on the second area to be 20. Each of the first area and the second area may be the non-light blocking area, but may also be the light blocking area.

As such, according to an embodiment of the present disclosure, the compression rate of image data may be adjusted according to the transparency of the area formed by the display 260. Accordingly, unnecessary waste of power consumption may be reduced, and data may be transmitted efficiently even in a wireless failure environment.

According to another embodiment of the present disclosure, the wireless transmitting device 100 may adjust the compression rate of image data based on an absence of the viewer. The wireless transmitting device 100 may detect the viewer's absence while transmitting compressed image data at a compression rate determined according to the light blocking state of the display 260 to the wireless receiving device 200.

The wireless transmitting device 100 may detect the viewer's absence based on a sensing signal obtained through an infrared detection sensor or an image signal obtained through a camera provided on the top of the display 260.

The wireless transmitting device 100 may further increase the determined compression rate when the viewer's absence is detected. If the viewer is not watching the video, unnecessary waste of power may be prevented by increasing the compression rate of the image data.

According to another embodiment of the present disclosure, the compression rate may be determined based on the light blocking state of the display 260 and a motion value of the image displayed in the light blocking area.

FIG. 14 is a flowchart illustrating a process of determining the compression rate based on the light blocking state of a display and the motion value of an image displayed in a light blocking area according to an embodiment of the present disclosure.

In FIG. 14, the light blocking method of the display 260 may be either the non-electronic light blocking method or the electronic light blocking method.

Referring to FIG. 14, the processor 190 of the wireless transmitting device 100 may determine whether the light blocking state of the display 260 is the full light blocking state or the partial light blocking state (S1401).

When the processor 190 determines that the light blocking state of the display 260 is the full light blocking state or the partial light blocking state, the processor 190 may determine the compression rate according to each state (S1403).

The processor 190 may obtain the motion value of an image displayed on a light blocking area in the full light blocking state or the partial light blocking state (S1405).

In one embodiment, the micro-computer 290 of the wireless receiving device 200 may extract a value of the motion vector of the image displayed in the light blocking area using a motion estimation/motion compensation (MEMC) technique to obtain the value of the extracted motion vector as the motion value of the image.

The MEMC technique may be a technique that extracts the difference between two consecutive video frames as a difference map and generates a frame to be inserted between a previous frame and a current frame following the previous frame using the extracted difference map.

The micro-computer 290 may extract the value of the motion vector corresponding to the image during the motion prediction process of the MEMC technique, and obtain the value of the extracted motion vector as the motion value of the image. The motion value may indicate a degree of movement of an object included in the image.

The micro-computer 290 may transmit the motion value of the image to the wireless transmitting device 100 through BLE communication.

If the motion value is less than a threshold (S1407), the processor 190 may change the determined compression rate to increase (S1409).

If the motion value of the image is less than the threshold, the processor 190 may determine the image to be an image with little movement of the object or still image to increase the compression rate of the image data, additionally.

As such, according to an embodiment of the present disclosure, the compression rate may be adjusted according to the light blocking state of the display 260 and the motion value of the image displayed on the light blocking area. Accordingly, the number of receiving antennas that are unnecessarily used may be reduced, thereby reducing power consumption.

When the light blocking state of the display 260 is the non-light blocking state, the processor 190 may determine the compression rate of image data corresponding to the non-light blocking state (S1411). This will be replaced with the description of step S803 in FIG. 8.

The wireless transmitting device 100 according to an embodiment of the present disclosure may comprise a compression chip 150 configured to compressed image data; an RF (Radio Frequency) transmitting interface 160 configured to, wirelessly, transmit the compressed image data to a wireless receiving device 200; and a processor 190 configured to: obtain a light blocking state of a display 260 provided in the wireless receiving device 200, and adjust a compression rate of the image data based on the obtained light blocking state.

The light blocking state indicates a degree of light blocking for an area of the display, wherein the processor 190 may decrease the compression rate as the degree of the light blocking increases, and increase the compression rate as the degree of the light blocking decreases.

The entire area of the display comprises a first area and a second area with different degree of light blocking, wherein the processor 190 may determine the compression rate of first image data corresponding to a first image to be displayed on the first area and the compression rate of a second image data corresponding to a second image to be displayed on the second area to be different from each other.

The processor 190 may increase the compression rate at a preset compression rate while a light blocking film disposed on a rear of the display is moved.

The processor 190 may obtain an ambient brightness of the display and re-adjust the compression rate based on the obtained ambient brightness.

The processor 190 may decrease the compression rate as the ambient brightness becomes brighter, and increase the compression rate as the ambient brightness becomes darker.

The light blocking state is one of a full light blocking state in which an entire area of the display 260 is light-blocked, a partial light blocking state in which a partial area of the display 260 is light-blocked, or a non-light blocking state in which the entire area of the display 260 is not light-blocked.

The processor 190 may adjust the compression rate based on a type of image displayed on the light blocking area in the partial light blocking state.

The processor 190 may determine the compression rate of content image data corresponding to an content image displayed on the light blocking area as a first compression rate when the type of the image is a content image type, and determine the compression rate of information image data corresponding to an information image displayed on the light blocking area as a second compression rate higher than the first compression rate when the type of the image is an information image type.

The processor 190 may determine the compression rate of the image data in the full light blocking state as a first compression rate, determine the compression rate of the image data in the non-light blocking state as a second compression rate higher than the first compression rate, in the partial light blocking state, determine the compression rate of the image to be displayed on the light blocking area as the first compression rate, and determine the compression rate of the image to be displayed on the non-light blocking area as the second compression rate.

The processor 190 may transmit, to a wireless receiving device 200, an on command to turn on an operation of a RF receiving interface with the best wireless performance among a plurality of RF receiving interfaces (240-1, 240-2) provided in the wireless receiving device 200, when the light blocking state of the display is in the partial light blocking state or the non-light blocking state.

The processor 190 may increase the adjusted compression rate when a viewer's absence is detected.

The processor 190 may increase the compression rate when a motion value of the image data is below a threshold.

The wireless transmitting device 100 may further comprise a wireless communication interface 120, the processor 190 may receive information on the light blocking state of the display 260 from the wireless receiving device 200 through the wireless communication interface 120.

According to an embodiment of the present disclosure, the above-described method may be implemented as processor-readable code on a program-recorded medium. Examples of media that the processor may read include ROM, RAM, CD-ROM, magnetic tape, floppy disk, and optical data storage device.

What is claimed is:

1. A wireless transmitting device, comprising:
a compression chip configured to compress image data;
a transmitter configured to wirelessly transmit the compressed image data to a wireless receiving device; and
a processor configured to:
obtain a light blocking state of a display provided in the wireless receiving device, and
adjust a compression rate of the image data based on the obtained light blocking state.

2. The wireless transmitting device of claim 1, wherein the light blocking state indicates a degree of light blocking for an area of the display,
wherein the processor is further configured to:
decrease the compression rate as the degree of the light blocking increases, and
increase the compression rate as the degree of the light blocking decreases.

3. The wireless transmitting device of claim 1, wherein an area of the display comprises a first area having a first degree of light blocking and a second area having a second degree of light blocking different from the first degree of light blocking,
wherein the processor is configured to:
determine a first compression rate of first image data corresponding to a first image displayed on the first area and a second compression rate of a second image data corresponding to a second image displayed on the second area,
wherein the first and second compression rates are different from each other.

4. The wireless transmitting device of claim 1, wherein the processor is configured to:
increase the compression rate at a preset compression rate while a light blocking film disposed on a rear of the display is moved.

5. The wireless transmitting device of claim 1, wherein the processor is further configured to:
obtain an ambient brightness of the display, and
re-adjust the compression rate based on the obtained ambient brightness.

6. The wireless transmitting device of claim 5, wherein the processor is configured to:
decrease the compression rate as the ambient brightness becomes brighter, and
increase the compression rate as the ambient brightness becomes darker.

7. The wireless transmitting device of claim 1, wherein the light blocking state is one of:
a full light blocking state in which an entire area of the display is light-blocked,
a partial light blocking state in which a partial area of the display is light-blocked, or
a non-light blocking state in which the entire area of the display is not light-blocked.

8. The wireless transmitting device of claim 7, wherein the processor is further configured to:
adjust the compression rate based on a type of image displayed on the light blocking area in the partial light blocking state.

9. The wireless transmitting device of claim 8, wherein the processor is configured to:
determine the compression rate of content image data corresponding to a content image displayed on the light blocking area as a first compression rate when the type of the image is a content image type, and
determine the compression rate of information image data corresponding to an information image displayed on the light blocking area as a second compression rate higher than the first compression rate when the type of the image is an information image type.

10. The wireless transmitting device of claim 7, wherein the processor is configured to:
determine the compression rate of the image data in the full light blocking state as a first compression rate,
determine the compression rate of the image data in the non-light blocking state as a second compression rate higher than the first compression rate,
in the partial light blocking state, determine the compression rate of the image to be displayed on the light blocking area as the first compression rate, and determine the compression rate of the image to be displayed on the non-light blocking area as the second compression rate.

11. The wireless transmitting device of claim 7, wherein the processor is further configured to:
transmit, to a wireless receiving device, an on command to turn on an operation of a RF receiving interface with the best wireless performance among a plurality of receiving interfaces provided in the wireless receiving device, when the light blocking state of the display is in the partial light blocking state or the non-light blocking state.

12. The wireless transmitting device of claim 1, wherein the processor is further configured to:
increase the adjusted compression rate when a viewer's absence is detected.

13. The wireless transmitting device of claim 1, wherein the processor is further configured to:
increase the compression rate when a motion value of the image data is below a predetermined threshold.

14. The wireless transmitting device of claim 1, further comprising a wireless communication interface,
wherein the processor is further configured to:
receive information on the light blocking state of the display from the wireless receiving device through the wireless communication interface.

15. A wireless display system including a wireless transmitting device and a wireless receiving device,
wherein the wireless transmitting device is configured to:
transmit a compressed image data to a wireless receiving device,
obtain a light blocking state of a display provided in the wireless receiving device, and
adjust a compression rate of the image data based on the obtained light blocking state,
wherein the wireless receiving device is configured to:
restore the compressed image data received from the wireless transmitting device and
display an image based on the restored image data on the display,
wherein the wireless receiving device includes a light blocking film disposed on one side of the display, and the light blocking film blocks light from an entire area or a partial area of the display using either a non-electronic light blocking method or an electronic light blocking method.

16. The wireless display system of claim 15, wherein the light blocking state indicates a degree of light blocking for an area of the display,
wherein the wireless transmitting device is configured to:
decrease the compression rate as the degree of the light blocking increases, and
increase the compression rate as the degree of the light blocking decreases.

17. The wireless display system of claim 15, wherein an area of the display comprises a first area having a first degree of light blocking and a second area having a second degree of light blocking different from the first degree of light blocking,
wherein the wireless transmitting device is configured to:
determine a first compression rate of first image data corresponding to a first image to be displayed on the first area and a second compression rate of a second image data corresponding to a second image to be displayed on the second area,
wherein the first and second compression rates are different from each other.

18. The wireless display system of claim 15, wherein the wireless transmitting device is configured to:
increase the compression rate at a preset compression rate while a light blocking film disposed on a rear of the display is moved.

19. The wireless display system of claim 15, wherein the wireless transmitting device is further configured to:
obtain an ambient brightness of the display and
re-adjust the compression rate based on the obtained ambient brightness.

20. The wireless display system of claim 19, wherein the wireless transmitting device is configured to:
decrease the compression rate as the ambient brightness becomes brighter, and
increase the compression rate as the ambient brightness becomes darker.
